(19) United States
(12) Patent Application Publication
(10) Pub. No.: US 2007/0189460 A1
(43) Pub. Date: Aug. 16, 2007

(54) Precise x-ray inspection system

(76) Inventors: Dean C. Buck, Loveland, CO (US); Ronald K. Kerschner, Loveland, CO (US); David C. Reynolds, Loveland, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/355,062

(22) Filed: Feb. 15, 2006

(51) Int. Cl. G21K 5/10

(52) U.S. Cl. 378/146

(57) ABSTRACT

Methods and apparatus for reducing detection of x-ray scatter in an x-ray system are described featuring one or more x-ray sources, one or more sensors, one or more field blocks configured to limit the field of view of the one or more sensors, one or more collimators configured to direct x-rays generated by the one or more x-ray sources in the direction of the one or more sensors, and a relative motion mechanism configured to alter a position of an object under inspection relative to the x-ray source and the one or more sensors.

### BACKGROUND OF THE INVENTION

X-ray inspection systems are often used to inspect objects that may be difficult to inspect using optical or other inspection techniques. For example, x-ray inspection systems are particularly useful in the inspection of objects that are embedded within, or are otherwise visually blocked by, other objects. X-ray inspection involves the capture of projected images of an object under inspection by one or more x-ray sensors. In this regard, one or more x-ray sources generate x-rays that may illuminate one or more sensors as attenuated by an intervening object under inspection. During image acquisition, the quality of the images captured by the one or more sensors may be limited due to the presence of x-ray scatter, which can result in loss of dynamic range in a captured image, thus reducing the system's inspection capability.

A need exists for improving the dynamic range of images captured by an x-ray inspection system.

### SUMMARY OF THE INVENTION

An embodiment of an x-ray inspection system comprises one or more x-ray sources, one or more sensors, one or more field blocks positioned between the one or more x-ray sources and the one or more sensors, the one or more field blocks configured to pass x-rays sourced directly by the one or more x-ray sources to respective ones of the one or more sensors and to block scattered x-rays from detection by the respective ones of the one or more sensors, and a relative motion mechanism configured to alter a position of an object under inspection relative to the one or more x-ray sources and the one or more sensors, the object under inspection passing between the one or more x-ray sources and the one or more field blocks.

An embodiment comprises a method comprising the steps of providing one or more x-ray sources, providing one or more sensors, providing one or more field blocks positioned between the one or more x-ray sources and the one or more sensors, the one or more field blocks configured to pass x-rays sourced directly by the one or more x-ray sources to respective ones of the one or more sensors and to block scattered x-rays from detection by the respective ones of the one or more sensors, and altering a position of an object under inspection relative to the one or more x-ray sources and the one or more sensors, passing the object under inspection between the one or more x-ray sources and the one or more field blocks.

An embodiment comprises a method comprising the steps of providing one or more x-ray sources, providing one or more sensors, providing one or more field blocks positioned between the one or more x-ray sources and the one or more sensors, the one or more field blocks configured to pass x-rays sourced directly by the one or more x-ray sources to respective ones of the one or more sensors and to block scattered x-rays from detection by the respective ones of the one or more sensors, and providing a position altering mechanism for altering a position of an object under inspection relative to the one or more x-ray sources and the one or more sensors, passing the object under inspection between the one or more x-ray sources and the one or more field blocks.

An embodiment of an x-ray inspection system comprises one or more x-ray sources, one or more sensors, one or more collimators collimating rays generated by the one or more x-ray sources into one or more x-ray beams directed to illuminate only one or more of the one or more sensors, one or more field blocks positioned between the one or more x-ray sources and the one or more sensors, the one or more field blocks configured to pass x-rays sourced directly by the one or more x-ray sources through one or more of the one or more collimators to respective ones of the one or more sensors and to block scattered x-rays from detection by the respective ones of the one or more sensors, and a relative motion mechanism configured to alter a position of an object under inspection relative to the one or more x-ray sources and the one or more sensors, the object under inspection passing between the one or more collimators and the one or more field blocks.

An embodiment comprises a method comprising the steps of providing one or more x-ray sources, providing one or more sensors, providing one or more collimators that collimate rays generated by the one or more x-ray sources into one or more x-ray beams directed to illuminate only one or more of the one or more sensors, providing one or more field blocks positioned between the one or more x-ray sources and the one or more sensors, the one or more field blocks configured to pass x-rays sourced directly by the one or more x-ray sources through one or more of the one or more collimators to respective ones of the one or more sensors and to block scattered x-rays from detection by the respective ones of the one or more sensors, and altering a position of an object under inspection relative to the one or more x-ray sources and the one or more sensors, passing the object under inspection between the one or more collimators and the one or more field blocks.

An embodiment comprises a method comprising the steps of providing one or more x-ray sources, providing one or more sensors, providing one or more collimators that collimate rays generated by the one or more x-ray sources into one or more x-ray beams directed to illuminate only one or more of the one or more sensors, providing one or more field blocks positioned between the one or more x-ray sources and the one or more sensors, the one or more field blocks configured to pass x-rays sourced directly by the one or more x-ray sources through one or more of the one or more collimators to respective ones of the one or more sensors and to block scattered x-rays from detection by the respective ones of the one or more sensors, and providing a position altering mechanism for altering a position of an object under inspection relative to the one or more x-ray sources and the one or more sensors, passing the object under inspection between the one or more collimators and the one or more field blocks.

An embodiment of an x-ray inspection system comprises one or more x-ray sources, one or more sensors, one or more field blocks positioned between the one or more x-ray sources and the one or more sensors, the one or more field blocks configured to pass x-rays sourced directly by the one or more x-ray sources to respective ones of the one or more sensors and to block scattered x-rays from detection by the respective ones of the one or more sensors, and a relative motion mechanism configured to alter a position of an object under inspection relative to the one or more x-ray sources and the one or more sensors in two or more directions, the object under inspection passing between the one or more x-ray sources and the one or more field blocks.

An embodiment comprises a method comprising the steps of providing one or more x-ray sources, providing one or more sensors, providing one or more field blocks positioned between the one or more x-ray sources and the one or more sensors, the one or more field blocks configured to pass x-rays sourced directly by the one or more x-ray sources to respective ones of the one or more sensors and to block scattered x-rays from detection by the respective ones of the one or more sensors, and altering a position of an object under inspection relative to the one or more x-ray sources and the one or more sensors in two or more directions, passing the object under inspection between the one or more x-ray sources and the one or more field blocks.

An embodiment comprises a method comprising the steps of providing one or more x-ray sources, providing one or more sensors, providing one or more field blocks positioned between the one or more x-ray sources and the one or more sensors, the one or more field blocks configured to pass x-rays sourced directly by the one or more x-ray sources to respective ones of the one or more sensors and to block scattered x-rays from detection by the respective ones of the one or more sensors, and providing a position altering mechanism for altering a position of an object under inspection relative to the one or more x-ray sources and the one or more sensors in two or more directions, passing the object under inspection between the one or more x-ray sources and the one or more field blocks.

An embodiment of an x-ray inspection system comprises one or more x-ray sources, one or more sensors, one or more collimators collimating rays generated by the one or more x-ray sources into one or more x-ray beams directed to illuminate only one or more of the one or more sensors, one or more field blocks positioned between the one or more x-ray sources and the one or more sensors, the one or more field blocks configured to pass x-rays sourced directly by the one or more x-ray sources through one or more of the one or more collimators to respective ones of the one or more sensors and to block scattered x-rays from detection by the respective ones of the one or more sensors, and a relative motion mechanism configured to alter a position of an object under inspection relative to the one or more x-ray sources and the one or more sensors in two or more directions, the object under inspection passing between the one or more collimators and the one or more field blocks.

An embodiment comprises a method comprising the steps of providing one or more x-ray sources, providing one or more sensors, providing one or more collimators that collimate rays generated by the one or more x-ray sources into one or more x-ray beams directed to illuminate only one or more of the one or more sensors, providing one or more field blocks positioned between the one or more x-ray sources and the one or more sensors, the one or more field blocks configured to pass x-rays sourced directly by the one or more x-ray sources through one or more of the one or more collimators to respective ones of the one or more sensors and to block scattered x-rays from detection by the respective ones of the one or more sensors, and altering a position of an object under inspection relative to the one or more x-ray sources and the one or more sensors in two or more directions, passing the object under inspection between the one or more collimators and the one or more field blocks.

An embodiment comprises a method comprising the steps of providing one or more x-ray sources, providing one or more sensors, providing one or more collimators that collimate rays generated by the one or more x-ray sources into one or more x-ray beams directed to illuminate only one or more of the one or more sensors, providing one or more field blocks positioned between the one or more x-ray sources and the one or more sensors, the one or more field blocks configured to pass x-rays sourced directly by the one or more x-ray sources through one or more of the one or more collimators to respective ones of the one or more sensors and to block scattered x-rays from detection by the respective ones of the one or more sensors, and providing a position altering mechanism for altering a position of an object under inspection relative to the one or more x-ray sources and the one or more sensors, passing the object under inspection between the one or more collimators and the one or more field blocks.

An embodiment of an x-ray inspection system comprises a single x-ray source, one or more sensors, one or more collimators collimating rays generated by the single x-ray source into one or more x-ray beams directed to illuminate only one or more of the one or more sensors, one or more field blocks positioned between the single x-ray source and the one or more sensors, the one or more field blocks configured to pass x-rays sourced directly by the single x-ray source through one or more of the one or more collimators to respective ones of the one or more sensors and to block scattered x-rays from detection by the respective ones of the one or more sensors, and a relative motion mechanism configured to alter a position of an object under inspection relative to the single x-ray source and the one or more sensors in two or more directions, the object under inspection passing between the one or more collimators and the one or more field blocks.

An embodiment of an x-ray inspection system comprises one or more x-ray sources, one or more sensors, one or more collimators collimating rays generated by the one or more x-ray sources into one or more x-ray beams directed to illuminate only one or more of the one or more sensors, and a relative motion mechanism configured to alter a position of an object under inspection relative to the one or more x-ray sources and the one or more sensors in two or more directions, the object under inspection passing between the one or more collimators and the one or more sensors.

An embodiment comprises a method comprising the steps of illuminating an object under inspection with x-rays generated by one or more x-ray sources, and limiting a field of view of one or more sensors onto which an image of the illuminated object is projected so as to pass x-rays sourced directly by the one or more x-ray sources to respective ones of the one or more sensors and to block scatter x-rays from detection by the respective ones of the one or more sensors.

An embodiment comprises a method comprising the steps of collimating x-rays generated by one or more x-ray sources into one or more beams directed to illuminate one or more sensors, illuminating an object under inspection with one or more of the one or more beams, and limiting a field of view of the one or more of the one or more sensors so as to pass x-rays in the one or more beams to the one or more of the one or more sensors and to block scattered x-rays from detection by the one or more of the one or more sensors.

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram of an x-ray inspection system;

FIG. 2 is a cross-sectional side view of an image acquisition model of a conventional image acquisition mechanism;

FIG. 3 is a cross-sectional side view of an image acquisition model of an embodiment of an image acquisition mechanism;

FIG. 4 is a flowchart illustrating an embodiment of a method for achieving improved image acquisition in an x-ray imaging system;

FIG. 5 is a flowchart illustrating an embodiment of a method for achieving improved image acquisition in an x-ray imaging system;

FIG. 6 is a cross-sectional side view of an image acquisition model of an embodiment of an image acquisition mechanism;

FIG. 7 is a flowchart illustrating an embodiment of a method for achieving improved image acquisition in an x-ray imaging system;

FIG. 8 is a flowchart illustrating an embodiment of a method for achieving improved image acquisition in an x-ray imaging system;

FIG. 9 is a cross-sectional side view of an image acquisition model of an embodiment of an image acquisition mechanism utilizing multiple sensors;

FIG. 10 is a cross-sectional side view of an image acquisition model of an embodiment of an image acquisition mechanism that utilizes a collimator;

FIG. 11 a cross-sectional side view of an image acquisition model of an embodiment of an image acquisition mechanism utilizing multiple sources and multiple sensors;

FIG. 12 is a cross-sectional side view of an image acquisition model of an embodiment of an image acquisition mechanism that utilizes multiple collimators and multiple field blocks;

FIG. 13 is a top plan view of an image acquisition model in which an object under inspection is transported relative x-ray source(s) and sensor(s) in one direction;

FIG. 14 is a top plan view of an image acquisition model in which an object under inspection is transported relative x-ray source(s) and sensor(s) in two or more directions;

FIG. 15 is a cross-sectional side view of components of an image acquisition mechanism illustrating the relative motion of an object under inspection with respect to stationary x-ray source(s) and sensor(s);

FIG. 16 is a cross-sectional side view of components of an image acquisition mechanism illustrating the relative motion of x-ray source(s) and sensor(s) with respect to a stationary object under inspection;

FIG. 17 is a cross-sectional side view of components of an image acquisition mechanism illustrating the relative motion of x-ray source(s) with respect to a stationary object under inspection and stationary sensor(s);

FIG. 18A is a perspective view of an exemplary embodiment of an image acquisition mechanism;

FIG. 18B is a cross-sectional side view of the image acquisition mechanism of FIG. 18A; and

FIG. 18C is a top view of an image acquisition mechanism illustrating transport path of an object under inspection;

FIG. 19 is a bottom view of a collimator that may be used in the embodiment shown in FIGS. 18A, 18B and 18C;

FIG. 20A is a perspective view of a field block;

FIG. 20B is a top view of a field block;

FIG. 21 is a cross-sectional side view of an image acquisition model of an embodiment of an image acquisition mechanism utilizing only a collimator to reduce scatter; and

FIG. 22 is a top plan view of an image acquisition model in accordance the embodiment of FIG. 21 in which the object under inspection is transported relative x-ray source(s) and sensor(s) in two or more directions.

### DETAILED DESCRIPTION

Methods and apparatus for reducing detection of x-ray scatter in an x-ray system are described. For simplicity and illustrative purposes, the principles of the embodiments are described. Moreover, in the following detailed description, references are made to the accompanying figures, which illustrate specific embodiments. Electrical, mechanical, logical, and structural changes may be made to the embodiments without departing from the spirit and scope of the embodiments.

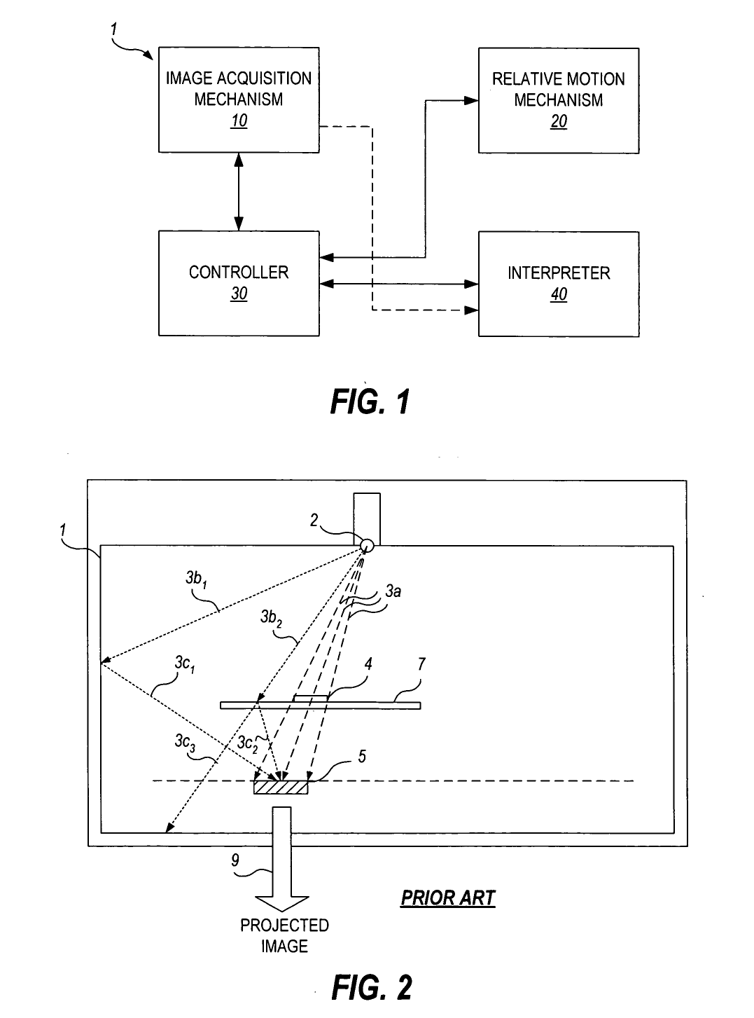

FIG. 1 is a functional block diagram of an x-ray system 1. In this system 1, an image acquisition mechanism 10 is employed to obtain projected images of an object under inspection as illuminated by one or more x-ray sources onto one or more sensors. A relative motion mechanism 20 operates to maneuver the object under inspection, the x-ray source(s), and the sensor(s) relative to each other to view the object under inspection relative the x-ray source(s) from a number of viewing angles.

An interpreter 40 processes acquired projected images to generate one or more reconstructed images. Each reconstructed image is a 2-dimensional image of a layer, imaged along a focal plane, of the 3-dimensional object. Reconstructed images may be generated for multiple focal planes. The interpreter 40 may process such reconstructed images in order to ascertain the overall quality of the object under inspection by comparing the reconstructed images with a preexisting database that the interpreter 40 uses as a comparative model. For example, in one embodiment, algorithmic image processing of the layer images may be performed on areas of particular interest of an object under inspection that is a PCB to determine the structural integrity and reliability of solder joints.

A controller 30 may be utilized to coordinate the actions of the image acquisition mechanism 10, the relative motion mechanism 20, and the interpreter 40. The controller 30 may also be used to facilitate the transfer of image data between the image acquisition mechanism 10 and the interpreter 40, although some embodiments may allow image data transfer directly from the image acquisition mechanism 10 to the interpreter 40.

Turning briefly to a description of a conventional image acquisition mechanism, FIG. 2 is an image acquisition model illustrating an object under inspection 4 that is positioned between an x-ray source 2 and a sensor 5 within an inspection cabinet 1. The x-ray source 2 radiates in all directions within the inspection cabinet 1. Some rays 3a, which are desired rays, pass through, and may be attenuated by, an object under inspection 4. These desired rays 3a are sensed by the sensor 5. Other rays 3b₁, 3b₂, which are undesired rays, may reflect off of system components, generating “scatter” rays 3c₁, 3c₂. As defined herein, the term “scatter” refers to reflected x-rays not directly originated by the x-ray source. For example, undesired ray 3b, reflects off a wall of the cabinet 8, generating scatter ray 3c₁. Additionally, undesired ray 3b₂ reflects off the support mechanism 7 of the object under inspection 4, generating scatter ray 3c₂. Scatter rays 3c₁, 3c₂ that reach and illuminate the sensor 5 are also sensed by the sensor 5. Scatter rays 3c₁, 3c₂ that are incident on, and therefore sensed by, a given sensor reduce the signal-to-noise (SNR) of the projected image 9.

In this regard, the desired rays 3a are attenuated by the object under inspection 4 (and any intervening support mechanism 7), and are sensed by the sensor 5. If the object under inspection 4 allows a significant amount of the radiation to pass through it (for example, when the object under inspection 4 is less dense), then the ratio of the desired ray 3a to the scattered rays 3c₁, 3c₂ is high, and the resulting projected image is relatively unaffected. If the amount of scatter is high, however, or if the object under inspection 4 is more dense and therefore attenuates most of the desired ray 3a, then the ratio of the desired ray 3a to the scattered rays 3c₁, 3c₂ at the sensor 5 is low, and the projected image is consequently adversely affected. Thus, the presence of scatter 3c₁, 3c₂ reduces the dynamic range of the projected images 9 generated by such x-ray inspection systems.

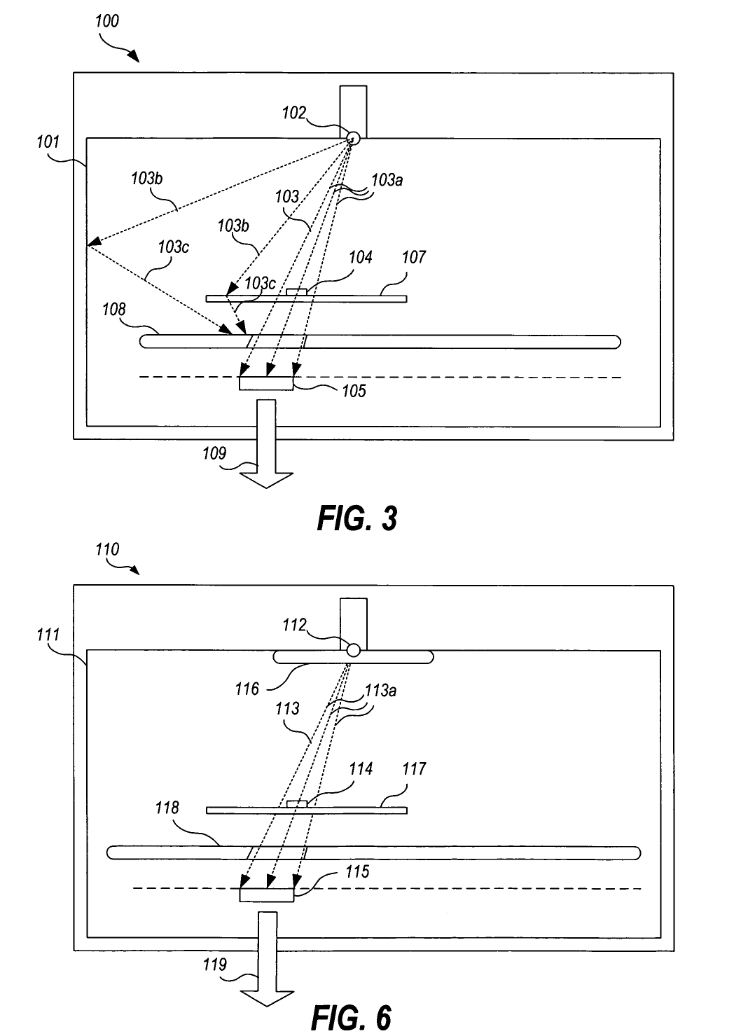

Embodiments for reducing detection of x-ray scatter in an x-ray system improve the conventional image acquisition mechanism. FIG. 3 illustrates an image acquisition model of an embodiment of an image acquisition mechanism 100.

The image acquisition mechanism 100 includes an x-ray source 102 that generates x-rays. In such an embodiment, x-rays generated by the x-ray source 102 radiate in all directions giving rise not only to desired rays 103a, but also to undesired rays 103b and scatter rays 103c.

In one embodiment, a field block 108 may limit the field of view of the sensor 105. As used herein, the field of view of a sensor is the area of the image field that is visible by the sensor. In the absence of a field block, the field of view of a sensor is substantially a 180° solid angle (taken from the point of view of the sensor as the vertex), and therefore a sensor will sense incident radiation from any direction within the 180° solid angle of the image field. The term “solid angle” as used herein refers to an angle formed by three or more planes intersecting at a common vertex. As used herein, the term “field block” refers to a device that limits the field of view of a sensor to a less than 180° solid angle. The field block 108 therefore greatly reduces the field of view of the sensor 105 to a limited solid angle, thereby operating to pass desired x-rays to the sensor 105 and to substantially block or absorb scatter rays 103c from detection by the sensor 105.

In one embodiment, a field block is a shielding device that includes a first portion of x-ray blocking material that prevents the transmission of x-rays therethrough and a second portion of x-ray transmissive material that allows the transmission of x-rays therethrough. The x-ray blocking material comprises one or both of x-ray absorptive material and x-ray reflective material. In one embodiment, the x-ray transmissive material comprises air. In one embodiment, the x-ray transmissive material comprises a low Z material (for example, aluminum or carbon).

In one embodiment, the x-ray transmissive material is configured as one or more windows or holes through the x-ray blocking material. In an embodiment, the one or more windows or holes are configured to align with sensors in an x-ray inspection system. In an embodiment, the x-ray blocking material may be positioned adjacent the x-ray transmissive material. In an embodiment, the x-ray blocking material may be positioned adjacent the x-ray transmissive material along one or more sides of the x-ray transmissive material while allowing transmission of x-rays through the x-ray transmissive material in at least one direction.

In an embodiment having an image model as shown in FIG. 3, an object under inspection 104 is positioned between the x-ray source 102 and the field block 108, rays 103a originating directly from the x-ray beam 103 in the direction of the sensor 105 pass through, and may be attenuated by, the object under inspection 104. Since the rays 103a from the x-ray beam 103 are directed at the sensor, they are within the field of view of the sensor 105. These desired rays 103a therefore are passed by the field block 108, and are thus sensed by the sensor 105 as projected image 109.

In an embodiment having an image model as shown in FIG. 3, undesired rays 103b not directed at the sensor 105 may be generated by the x-ray source 102, which may result in scatter rays 103c that are directed at the sensor 105. The field block 108 blocks (for example by absorption or reflection) most of the undesired scatter rays 103c that do not have a straight-line path from the source 102 (i.e., rays that have been reflected off of system or object components). Hence, many of the scatter rays (such as scatter rays 3c₁, 3c₂) do not reach the sensor 105 and therefore do not contribute to the projected image 109 acquired from the sensor 105.

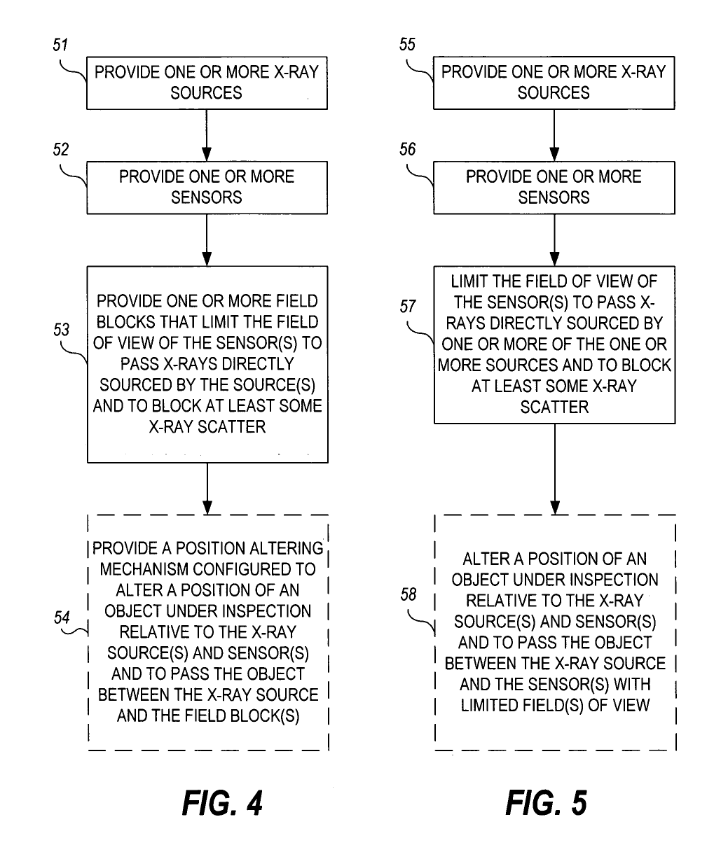

FIG. 4 shows steps of an embodiment for achieving improved image acquisition in an x-ray imaging system. This embodiment includes steps of providing one or more x-ray sources (step 51), providing one or more sensors (step 52), providing one or more field blocks positioned between the one or more x-ray sources and the one or more sensors, the one or more field blocks configured to pass x-rays directly sourced by the source(s) and directed at one or more of the sensor(s) and to block scattered x-rays from detection by the respective ones of the one or more sensors (step 53), and providing a position altering mechanism configured to alter a position of an object under inspection relative to the x-ray source(s) and the sensor(s), passing the object under inspection between the x-ray source(s) and the field block(s) (step 54).

FIG. 5 shows steps of an embodiment for achieving an improved image acquisition in an x-ray imaging system. This embodiment includes steps of providing one or more x-ray source(s) (step 55), providing one or more sensor(s) (step 56), limiting the field of view of the one or more sensors to pass x-rays sourced directly by the source(s) to respective ones of the sensor(s) and to block (at least some) scattered x-rays from detection by the respective ones of the sensor(s) (step 57), and altering a position of an object under inspection relative to the x-ray source(s) and the sensor(s), passing the object under inspection between the x-ray source(s) and the sensor(s) with limited field(s) of view (step 58).

When x-rays encounter any of the components in the inspection cabinet, including inspection cabinet walls, an object transport mechanism, any support on which the object under inspection is mounted, or even components of the object itself, a portion of the x-rays reflect in another direction. X-rays can continue to reflect, bouncing off system components, until they eventually become attenuated enough as to be negligible. Use of x-ray absorptive material on the interior walls of the inspection cabinet 8 may absorb most of the undesired x-rays reaching the cabinet walls; however, scatter may still be generated by x-ray reflection off of other system components such as the transport mechanism, or even components within the object itself (for example, metal layers, solder joints, and vias within a PCB).

FIG. 6 illustrates an image acquisition model of an embodiment of an image acquisition mechanism 110, which includes the same components as the embodiment of FIG. 3 but additionally includes a collimator 116 that collimates the x-rays generated by the x-ray source 112 into one or more fan beams 113 that directed to illuminate only one or more sensor(s) 115 within the inspection cabinet 111. As used herein, the term “collimator” refers to a device that produces one or more fan beams from one or more x-ray sources. As used herein, the term “fan beam” refers to an x-ray beam having a constant ratio of major to minor dimension at any transverse cross section. Each fan beam is directed at a respective sensor 115 along a respective controlled solid angle. In one embodiment, the collimator 116 is configured to produce one or more fan beams 113 having respective ratios of major to minor dimensions that substantially match respective ratios of major to minor dimensions of corresponding sensor areas. The collimator therefore determines the absolute solid angle of each of one or more x-ray beams, along with the shape and size of the illuminated area in the imaging plane. In one embodiment, the collimator is configured to generate fan beam(s) that substantially illuminate only the sensing area of the sensor(s) located in the imaging plane.

When an object under inspection 114 is positioned between the collimator 116 and the field block 118, rays 113a from the x-ray beam 113 pass through, and may be attenuated by, the object under inspection 114. Since the rays 113a from the x-ray beam 113 are directed at the sensor, they are within the field of view of the sensor 115. These desired rays 113a therefore are passed by the field block 118, and are thus sensed by the sensor 115 as projected image 119. The projected image 119 as sensed by the sensor 115 may be captured as an individual projection of the object under inspection 114 at the viewing angle, which may be defined by the position of the sensor 115 relative the position of the x-ray source 112.

In an embodiment having an image model as shown in FIG. 6, the collimator 116 prevents undesired rays (such as rays 3b₁, 3b₂ in the conventional image acquisition mechanism shown in FIG. 2) from reaching the sensor 115 by directing the rays generated by the x-ray source 112 substantially only at the sensor 115. The collimator 116 therefore assists in reducing the overall scatter.

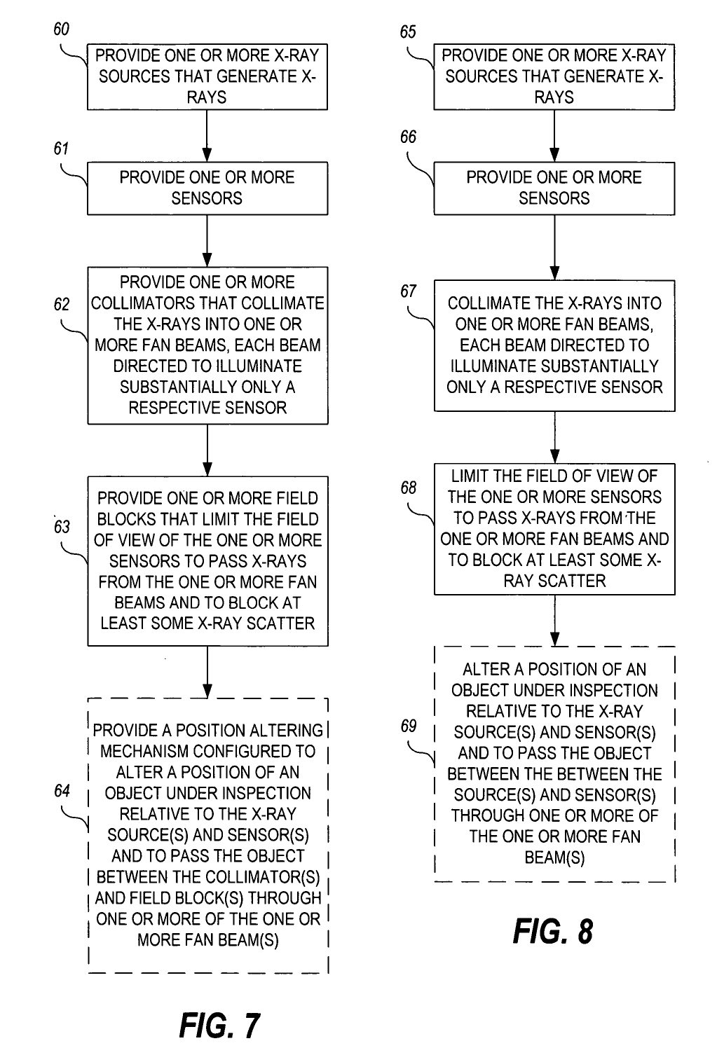

FIG. 7 shows steps of an embodiment for achieving improved image acquisition in an x-ray imaging system. This embodiment includes steps of providing one or more x-ray sources (step 60), providing one or more sensors (step 61), providing one or more collimators that collimate rays generated by the x-ray source(s) into one or more fan beams directed to illuminate (preferably only) the sensor(s) (step 62), providing one or more field blocks positioned between the source(s) and the sensor(s) (step 63), and providing a position altering mechanism configured to alter a position of an object under inspection relative to the x-ray source(s) and the sensor(s) and to pass the object under inspection between the collimator(s) and the field block(s) through one or more of the one or more fan beams (step 64).

FIG. 8 shows steps of an embodiment for achieving improved image acquisition in an x-ray imaging system. This embodiment includes steps of providing one or more x-ray sources (step 65), providing one or more sensors (step 66), collimating rays generated by the x-ray source(s) into one or more fan beams directed to illuminate (preferably only) the sensor(s) (step 67), limiting the field of view of the sensor(s) to pass x-rays that are part of the one or more fan beams and to block x-rays that are not part of the one or more fan beams (step 68), and altering a position of an object under inspection relative to the x-ray source(s) and the sensor(s) and to pass the object under inspection between the x-ray source(s) and the sensors(s) through one or more of the one or more fan beam(s) (step 69).

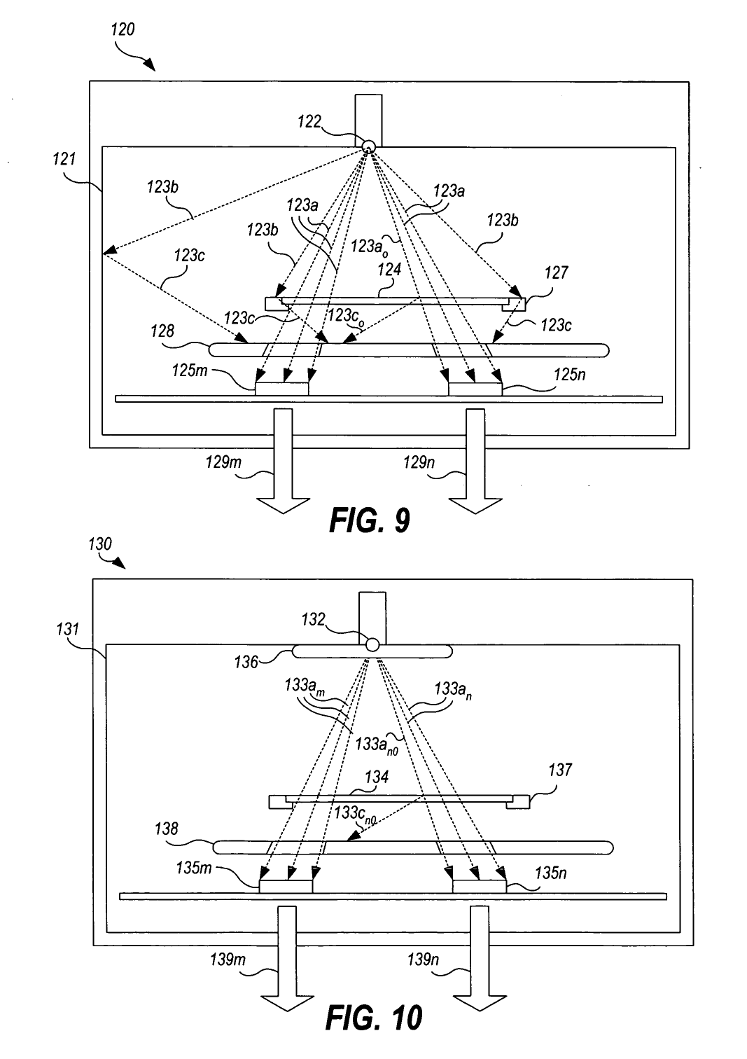

FIG. 9 illustrates an image acquisition model of an embodiment of an image acquisition mechanism 120, which includes the same components as the embodiment of FIG. 3 but includes multiple sensors 125m, 125n aligned along an imaging plane, each sensor 125m, 125n protected by a field block 128 that limits the view of the respective sensors to the view of the source 122.

When an object under inspection 124 is positioned between the source 122 and the field block(s) 128, desired rays 123a from the source 122 pass through, and may be attenuated by, the object under inspection 124. Since the desired rays 123a originating from the source 122 are directed at the sensors 125m, 125n, they are within the field of view of the sensors 125m, 125n. These desired rays 123a therefore are passed by the field block 128, and are thus sensed by the sensors 125m, 125n. The projected images 129m, 129n as sensed by respective sensors 125m, 125n may be captured as an individual projections of the object under inspection 124 at the particular viewing angles defined by the respective positions of the respective sensors 125m, 125n relative the position of the x-ray source 122.

In an embodiment having an image model as shown in FIG. 9, undesired rays 123b outside the field of view of the sensors 125m, 125n may be generated by the x-ray source 122, which may result in scatter rays 123c. Furthermore, scatter rays 123c₀ may be generated by reflection off of components within the object under inspection 124 itself. For example, as shown in FIG. 9, a portion of ray 123a₀ may be reflected off of a component within the object under inspection 124 in the direction of sensor 125m to generate a scatter ray 123c₀. The field block 128 substantially prevents the passing of undesired scatter rays 123c₀ that are outside the field of view of the sensors 125m, 125n from the respective point of views of the sensors 125m, 125n. Hence, many of the scatter rays 123c do not reach the sensors 125m, 125n and therefore do not contribute to the projected images 129m, 129n acquired by the sensors 125m, 125n.

FIG. 10 illustrates an image acquisition model of an embodiment of an image acquisition mechanism 130, which includes the same components as the embodiment of FIG. 9 but additionally includes a collimator 136 that collimates the x-rays generated by the x-ray source 132 into x-ray fan beam 133aₘ that is directed to illuminate only the sensor 135m within the inspection cabinet 131 and x-ray fan beam 133aₙ that is directed to illuminate only the sensor 135n within the inspection cabinet 131.

When an object under inspection 134 is positioned between the collimator 136 and the field block 138, rays from the x-ray fan beams 133aₘ and 133aₙ pass through, and may be attenuated by, the object under inspection 134. Since the rays from the x-ray fan beams 133aₘ, 133aₙ are respectively directed at the sensors 135m, 135n, the collimator 136 effectively prevents unnecessary generation of scatter within the cabinet by limiting the original rays to the direction of the actual sensors. Furthermore, since these desired rays are within the field of view of the respective sensors 135m, 135n, these desired rays from the x-ray beams 133aₘ, 133aₙ therefore are passed by the field block 138 to be sensed by the respective sensors 135m, 135n. The projected images 139m, 139n of the portion of the object under inspection 134 as sensed by the respective sensors 135m, 135n may be captured as individual projections of the object under inspection 134 at the particular respective viewing angles defined by the position of the respective sensors 135m, 135n relative the position of the x-ray source 132.

In an embodiment having an image model as shown in FIG. 10, the field block 138 further assists in preventing the passing of scatter rays 133cₙ₀ to the sensors 135m, 135n. It will be noted that although the collimator 136 substantially eliminates scatter resulting from undesired rays, some of the desired rays 133aₙ₀ may yet generate some small amount of scatter rays 133cₙ₀ due to reflection off of components within the object under inspection 134 itself. For example, as shown in FIG. 10, a portion of desired ray 133aₙ₀ may be reflected off of a component within the object under inspection 134 in the direction of sensor 135m to generate a scatter ray 133cₙ₀. Again, the field block 138 operates to block the scatter ray 133cₙ₀.

FIG. 11 illustrates an image acquisition model of an embodiment of an image acquisition mechanism 140 that utilizes multiple x-ray sources 142m, 142n and multiple sensors 145m, 145n that are protected from illumination by scatter by one or more field block(s) 148 that limit the view of the respective sensors 145m, 145n to the view of the respective sources 142m, 142n.

When an object under inspection 144 is positioned between one or more of the sources 142m, 142n and the field block(s) 148, desired rays 143aₘ, 143aₙ from the sources 142m, 142n may pass through, and may be attenuated by, the object under inspection 144. Since the desired rays 143aₘ, 143aₙ originating from the sources 142m, 142n are directed at the sensors 145m, 145n, they are within the field of view of the sensors 145m, 145n. These desired rays 143aₘ, 143aₙ therefore are passed by the field block(s) 148, and are thus sensed by the sensors 145m, 145n. The projected images 149m, 149n as sensed by respective sensors 145m, 145n may be captured as individual projections of the object under inspection 144 at the particular viewing angles defined by the respective positions of the respective sensors 145m, 145n relative the position of the respective x-ray sources 142m, 142n.

In an embodiment having an image model as shown in FIG. 11, undesired rays 143b outside the field of view of the respective sensors 145m, 145n may be generated by the respective x-ray sources 142m, 142n, which may result in scatter rays 143c. The field block 148 prevents the passing of undesired scatter rays 143c that are outside the field of view of the respective sensors 145m, 145n. Hence, many of the scatter rays (such as scatter rays 143c) do not reach the respective sensors 145m, 145n and therefore do not contribute to the projected images 149m, 149n acquired by the sensors 145m, 145n.

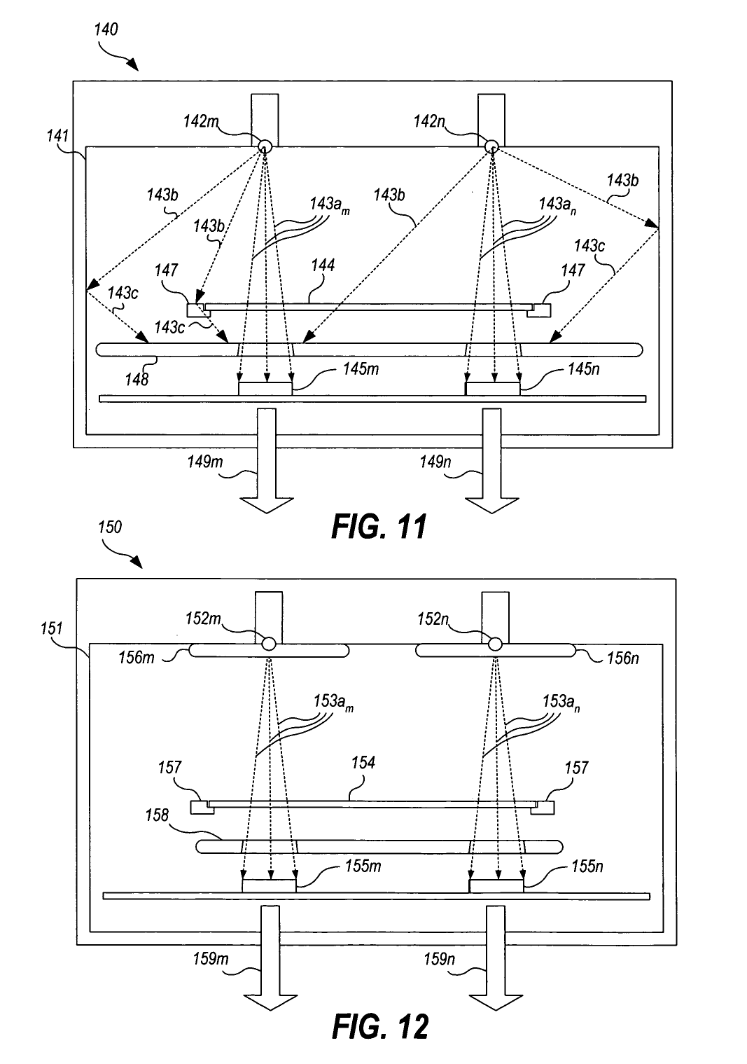

FIG. 12 illustrates an image acquisition model of an embodiment of an image acquisition mechanism 150, which includes the same components as the embodiment of FIG. 11 but additionally includes one or more collimators 156m, 156n that collimate the x-rays generated by the x-ray sources 152m, 152n into x-ray fan beams 153aₘ, 153ₙ that are directed to illuminate the sensors 155m, 155n within the inspection cabinet 151.

When an object under inspection 154 is positioned between the collimators 156m, 156n and the field block 158, rays 153a from the x-ray fan beams 153aₘ and 153aₙ pass through, and may be attenuated by, the object under inspection 154. Since the rays 153a from the x-ray fan beams 153aₘ, 153aₙ are respectively directed at the sensors 155m, 155n, the collimators 156m, 156n effectively prevents unnecessary generation of scatter within the cabinet by limiting the original rays to the direction of the actual sensors. Furthermore, since these desired rays 153a are within the field of view of the respective sensors 155m, 155n, as defined by the field block 158, these desired rays 153a therefore are passed by the field block 158 to be sensed by the respective sensors 155m, 155n. The projected images 159m, 159n of the portion of the object under inspection 154 as sensed by the respective sensors 155m, 155n may be captured as individual projections of the object under inspection 154 at the particular respective viewing angles defined by the position of the respective sensors 155m, 155n relative the position of the respective x-ray sources 152m, 152n.

It will be appreciated that embodiments of the image acquisition mechanisms, including type and number of x-ray sources and sensors, and the method and path of respective movement of the x-ray source(s), sensor(s), and object under inspection, may be variously configured depending on the particular technique of image acquisition utilized by the particular x-ray system.

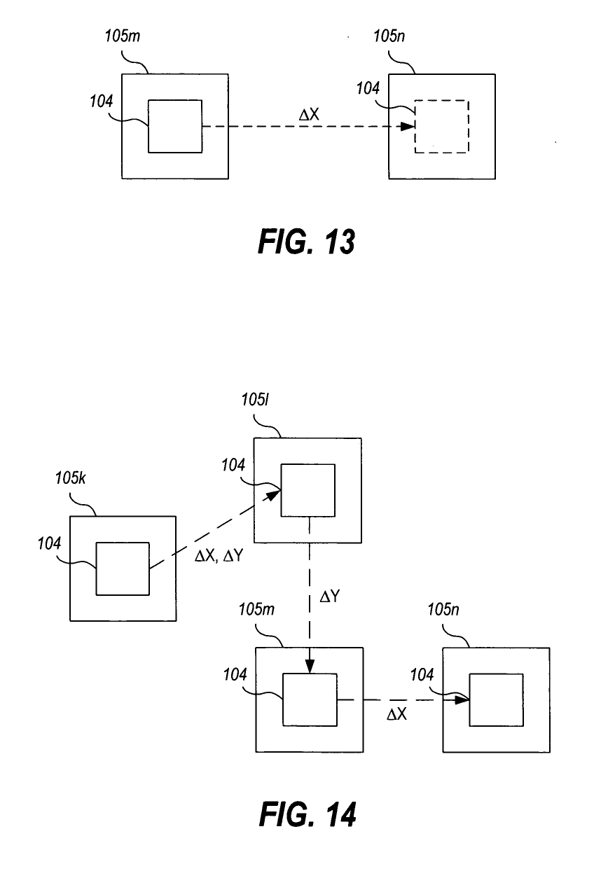

In one embodiment, for example as shown in FIG. 13, the object under inspection 104 is transported in one direction only, indicated by arrow ΔX, relative stationary x-ray sources (not shown) and stationary sensors 105m, 105n. In one embodiment, for example as shown in FIG. 14, the object under inspection is transported in two or more directions, indicated by arrows labeled ΔXΔY, ΔY, and ΔX, relative stationary x-ray sources (not shown) and stationary sensors 105k, 105l, 105m, 105n.

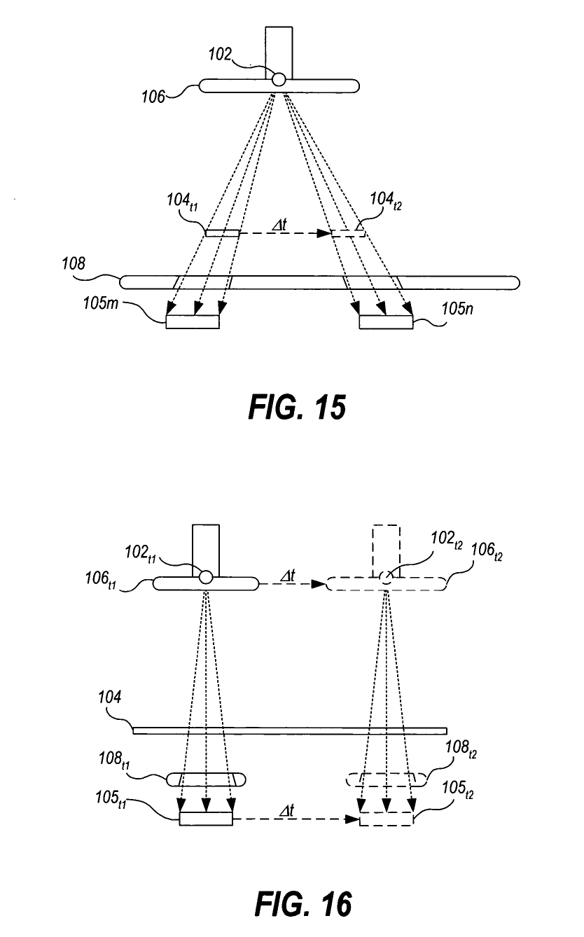

In one embodiment, shown in FIG. 15, the source(s) 102, sensor(s) 105m, 105n, field block(s) 108, and collimator(s) 106 remain stationary, while the object under inspection 104 is transported to different positions therebetween to obtain different viewing angles of the object.

In one embodiment, shown in FIG. 16, the source(s) 102, sensor(s) 105, field block(s) 108, and collimator(s) 106 remain stationary relative each other, but are moved together to different positional locations while the object under inspection 104 remains stationary. In one embodiment, the source(s) and sensor(s) moving as a unit are transported in one direction only. In one embodiment, the source(s) and sensor(s) moving as a unit are transported in two or more directions.

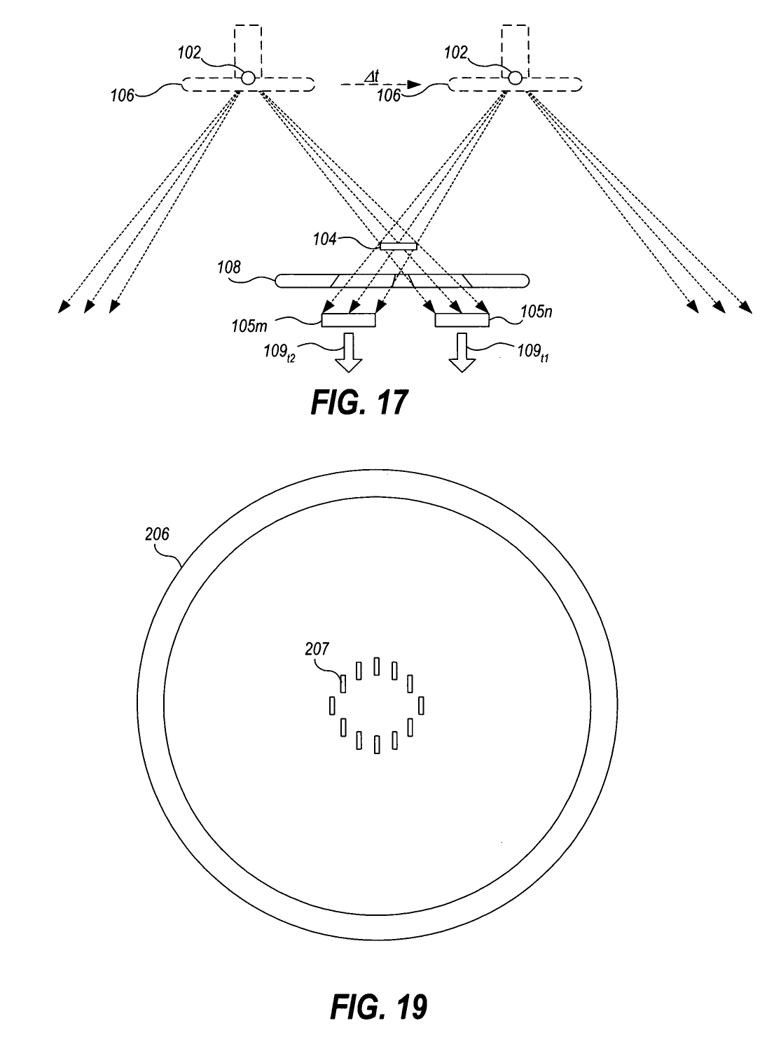

In one embodiment, shown in FIG. 17, the sensor(s) and object under inspection are stationary, while the source moves.

In one embodiment, not shown, all three of the source(s), sensor(s), and object under inspection may be moved relative to one another.

The sensor(s) may be implemented with any x-ray sensitive device that can sense intensity of x-ray exposure and be captured as an image for processing by a processor. In one embodiment, the image is digital. In one embodiment, the image is analog, for example when captured by an image intensifier. Analog images will typically be converted to digital format prior to processing.

In one embodiment, the sensor(s) may comprise an image intensifier. For example, two or more discrete images may be generated by way of a single large stationary image intensifier or several smaller stationary area image sensors by allowing the x-ray source to dwell at particular angles through the area of interest on the object. The resulting discrete image at each beam orientation is then stored digitally. Examples of image acquisition using an image intensifier is described in detail in U.S. Pat. No. Re. 35,423 to Adams et al., and in U.S. Pat. No. 5,020,086 to Peugeot, both of which are hereby incorporated by reference for all that they teach.

In one embodiment, the sensors may comprise digital area array sensors. In one embodiment, the sensors may comprise digital line sensors.

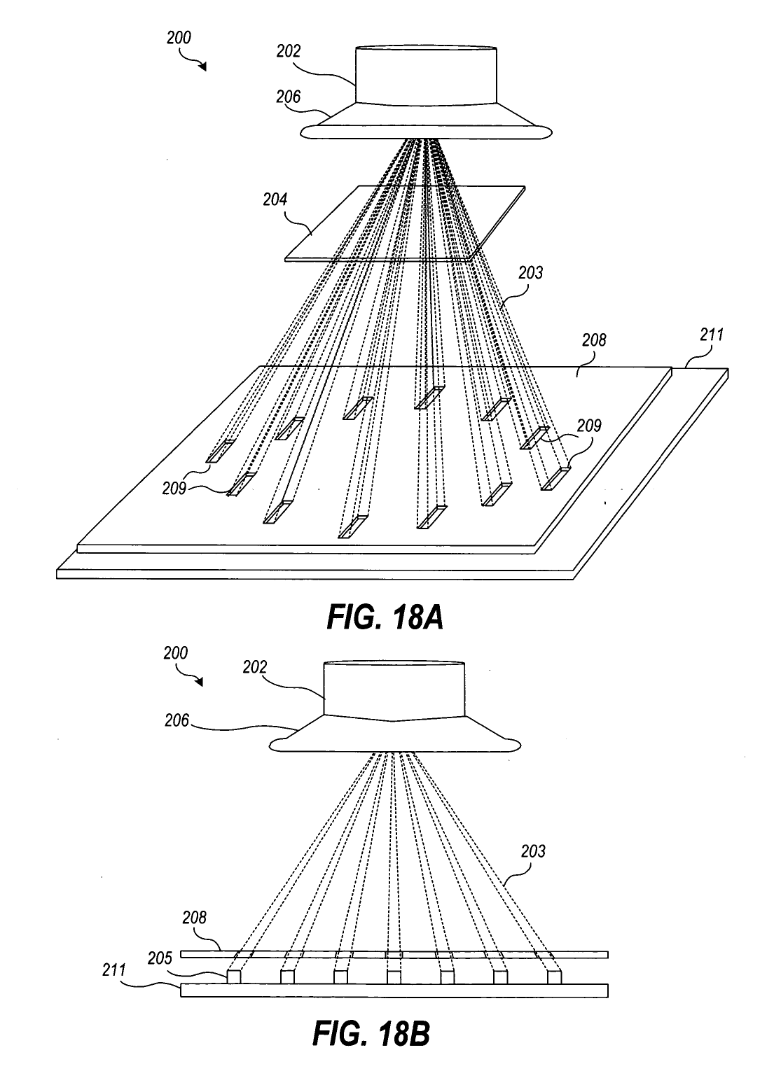

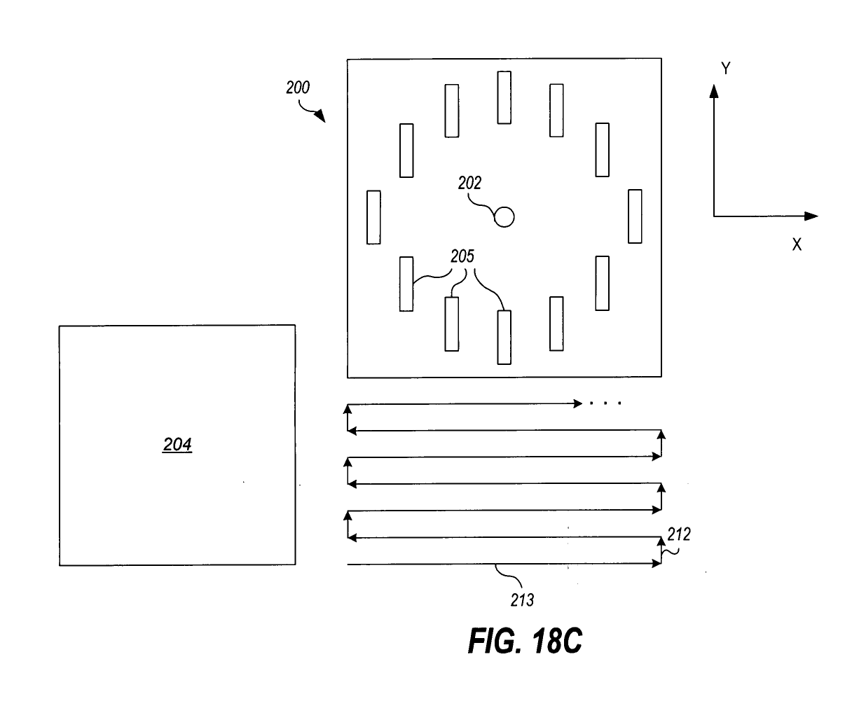

FIGS. 18A, 18B, and 18C respectively show a perspective view, a cross-sectional side view, and an image model, of an embodiment of an exemplary image acquisition mechanism 200. In image acquisition mechanism 200, x-ray source 202 is employed to irradiate a planar array of sensors 205 that are sensitive to x-rays. The x-ray source 202 remains stationary relative to the array of sensors 205, projecting x-rays toward all of the sensors 205 simultaneously.

In one embodiment, a collimator 206 is employed to restrict x-ray exposure to the locations occupied by the sensors 205 and the intervening areas of the object under inspection in order to limit overall x-ray exposure of the object and to improve the dynamic range of the images captured by the sensors 205. To this end, the collimator 206 generates respective fan beams 203 directed at each of the respective sensors 205.

In one embodiment, a field block 208 is positioned between the x-ray source 202 and the sensors 205 close to the array of sensors. The field block 208 is preferably implemented as a plate comprising x-ray absorbing material and comprising a respective window located over each sensor 205. Each window is positioned to expose only the corresponding sensor to the source 202. Furthermore, the field block 208 is positioned a sufficient distance away from the sensor(s) (i.e., the imaging plane) so as to limit the field of view of the respective sensors mainly to that of the corresponding fan beam directed at it. The field block 208 is therefore configured to pass x-rays sourced directly by the x-ray source 202 to respective ones of the sensors 205 and to block detection of reflected or scatter x-rays by the respective sensors 205. In this embodiment, the relative motion mechanism 20 (from FIG. 1) is configured to alter a position of the object under inspection 204 relative to the x-ray source 202, sensors 205, collimator 206, and field block 208, passing the object under inspection 204 between the x-ray source 202 (or collimator 206, if present) and field block 208.

In one embodiment, both the collimator 206 and the field block 208 are included. In this embodiment, the collimator 206 is positioned close to the x-ray source 202 and configured to collimate x-rays generated by the x-ray source into one or more fan beams directed at corresponding ones of the sensors 205 without encountering any intervening reflective system component. In this embodiment, the field block 208 is positioned close to the array of sensors 205 and is configured to pass x-rays sourced directly by the x-ray source 202 to respective ones of the sensors 205 and to block detection of reflected or scatter x-rays by the respective sensors 205. In this embodiment, the relative motion mechanism 20 (FIG. 1) is configured to alter a position of the object under inspection 204 relative to the x-ray source 202, sensors 205, collimator 206, and field block 208, passing the object under inspection 204 between the collimator 206 and the field block 208.

An object 204 to be inspected (not shown in FIG. 18B but shown in FIGS. 18A and 18C) is positioned between the x-ray source 202 and the sensors 205, subject to the positioning of the collimator 206 and field block 208, as described above, so that each of the sensors 205 may capture projection images of the object after the x-rays have transmitted through the object, the x-rays being collimated as described in detail hereinafter. Each of the sensors 205 are positioned relative to the x-ray source 202 so that the projection image of the object captured by each sensor 205 is acquired at a distinct angle relative to the x-ray source 202. In one embodiment, shown in FIG. 18A, a total of twelve sensors 205 are arranged in a circular configuration, resulting in a difference in viewing angle between adjacent sensors 205 of approximately 30 degrees. While any number of sensors 205 may be employed to generate different viewing angles of the object under inspection, preferably utilizing a range of twelve to sixteen linear sensors (discussed hereinafter) appears to generate a sufficient number of images for proper inspection of an object under inspection such as a PCB. Also, while a circular configuration of the sensors 205 is implemented in the example of FIG. 18A, any number of different sensor arrangements, such as those defining a square, diamond, or a more randomized pattern, may be utilized. Depending on the application, the configuration selection may be based to some extent on the ease of implementation of the selected configuration, and the desired image quality of the type of objects to be inspected. Each of the sensors 205 is stationary relative to each other and to the x-ray source 202 by way of attachment to a stable base 211, as shown in FIGS. 18A, 18B, and 18C.

FIG. 19 is a bottom view of the collimator 206 shown in FIGS. 18A and 18B. The collimator 206 includes a number of windows 207 (generally matching the number of sensors), each angled to be directed at a corresponding sensor 205 and each having the same ratio of major to minor dimension as its corresponding sensor 205. Each window 207 is therefore configured to generate a respective fan beam directed at its corresponding sensor 205. The size and angle of each window is configured such that when the x-ray source 202, collimator 206, and sensors 205 are mounted in their respective fixed positions in the x-ray image acquisition apparatus 200, each respective sensor 205, and preferably only each respective sensor 205, is illuminated by a corresponding fan beam output by the collimator 205.

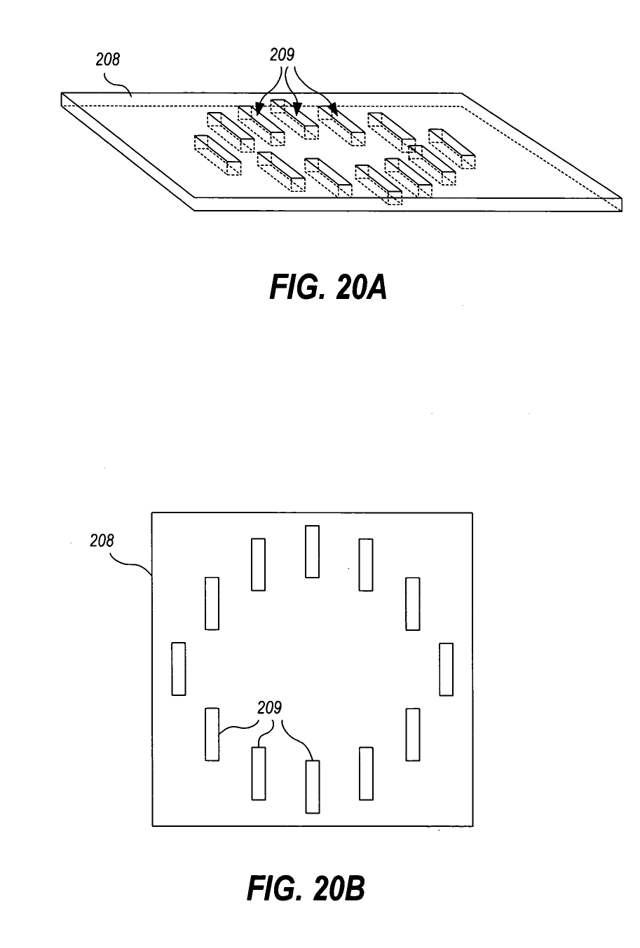

FIG. 20A is a perspective view, and FIG. 20B is a top view, of the field block 208 shown in FIGS. 18A and 18B. The field block 208 includes a number of windows 209, each positioned to allow a corresponding fan beam to illuminate a corresponding sensor 205, and each having the same ratio of major to minor dimension as its corresponding sensor 205. Each field block window 209 is sized and angled to preferably allow full illumination of a corresponding sensor (and preferably only of that corresponding sensor) by a corresponding fan beam when the x-ray source 202, collimator 206, field block 208, and sensors 205 are mounted in their respective fixed positions in the x-ray image acquisition apparatus 200.

In one embodiment, the relative motion mechanism 20 (FIG. 1) transports the object under inspection 204 (FIG. 18C) according to a transport path. For example, in one embodiment, the relative motion mechanism 20 (FIG. 1) collects images in a series of scan steps 212 and passes 213, as shown in FIG. 18C, and described in detail in U.S. Pat. Application Publication 2004/0184576 A1, to Gerald Meyer, hereby incorporated by reference for all that it teaches.

In one embodiment, the one or more sensors 205 are line sensors. The sensors 205, in some embodiments, are standard linear sensors, each having a single row of several hundred to a few thousand imaging pixels, which are adapted to be sensitive to the x-rays from the x-ray source 202. For example, the sensors 205 may be commercially available 300 dot-per-inch (DPI) or 600 DPI charge-coupled device (CCD) sensors mounted with a fiber optic plate (FOP) and a cesium-iodide x-ray scintillator. Voltages denoting the x-ray intensity level detected by each pixel typically are transferred to an analog-to-digital converter (ADC) that is read by the controller 30 (FIG. 1) or the interpreter 40 (FIG. 1) of the system 200. Alternatively, the sensors 205 may be time delay integration (TDI) linear sensors, which employ multiple rows of sensors to integrate the charge generated as a result of the received x-rays before being converted to a voltage. TDI linear sensors are known in the art for their excellent sensitivity and applicability in high-speed imaging applications. Other sensors that are sensitive to x-rays may also be employed in the system 200, depending on the technical requirements of the application involved.

To capture images of all areas of interest of the object under inspection 204 in a scanning system, the relative motion mechanism 20 (FIG. 1) moves the object between the x-ray source 202 and the array of sensors 205 in a path designed to capture images of the object under inspection from a variety of viewing angles. In one embodiment, where the sensors 205 comprise linear sensors arranged in parallel, the relative motion mechanism 20 moves the object under inspection between the x-ray source 202 and the array of linear sensors 205 in a series of passes 213 over the sensors 205 substantially perpendicular to the long axis of each sensor. For example, FIG. 18C displays an object under inspection 204. In one embodiment, the object under inspection 204 is a PCB that is to be inspected for defects, such as solder bridges, circuit trace breaks, and the like. As shown by the directional arrows in FIG. 18C, the relative motion mechanism 20 (FIG. 1) causes the object under inspection 204 to make a scan pass 213 over the sensors 205 and under the x-ray source 202 in the x-direction perpendicular to the y-axis-aligned sensors 205. As this scan pass 213 occurs, each sensor 205 that is located under the object under inspection 204 captures a linear image of the object under inspection 204 from a different viewing angle. By the time the scan pass is complete, each respective sensor 205 has captured a swath of the object under inspection 204 as seen from the respective viewing angle of the sensor. A swath as used herein refers to an area of the object under inspection 204 within the field of view of the respective sensor 205. The object is then advanced by a “scan step” 212 in the y-direction. The relative motion mechanism 20 (FIG. 1) then moves the object under inspection 204 in the negative x-direction by way of another scan pass 213, during which time each sensor 205 captures another swath of the object under inspection 204. The motion of the object under inspection 204 progresses in this manner until the desired area of the object under inspection 204 has been captured by all sensors 105. As can be seen in FIG. 18C, due to the diverse locations of the various sensors 205, each sensor likely has collected a different amount of the overall image of the object under inspection 204 at any particular moment while the object under inspection 204 is being transported by the relative motion mechanism 20 (FIG. 1).

In one embodiment, the distance of each scan step 212 of the object is essentially the “sensor length of view” for each sensor, which in turn is related to the actual length of each sensor so that no areas of the object under inspection 204 are missed, while at the same time no significant overlap of the separate swaths of the object under inspection 204 taken by each scan pass 213 occurs.

As can be seen from the foregoing discussion, the dimensions of each of the sensors 205 is not related directly to the dimensions of the object under inspection, as any number of multiple scan passes 201 may be made to create projection images of the entire object. Thus, no substantive limit exists on the size and shape of the object under inspection relative to the size and shape of the sensors 205 used, thus allowing relatively small and inexpensive sensors to be employed in the design of the system 200.

In one embodiment, during scanning, the movement of the object under inspection is essentially at a constant velocity during each of the scan passes 213, so a mechanism requiring fast object acceleration and short settling times is not necessary. Furthermore, all changes of direction (between the x and y directions) occur while no imaging is being performed, so lower performance mechanics with respect to changes of direction may be tolerated.

The relative motion mechanism 20 (FIG. 1) may typically consist primarily of a set of inexpensive stepper motors under the direction of the controller 30 (FIG. 1), although other motor technologies, such as direct current (DC) servo motors, may also be employed. Alternately, the relative motion mechanism 20 may instead move the x-ray source 202, the sensors 205, collimator 206, and field block 208 in relation to a stationary object under inspection in a manner as described above; such a system may be preferable for large bulky objects.

In another embodiment, the relative motion mechanism 20 (FIG. 1) moves the object according to a “scoot-and-shoot” image capturing method. In the scoot-and-shoot image capturing method, the object under inspection is moved to a given location in a given x-y plane. Once positioned at the given location, movement of the object under inspection is halted, and the image of the object under inspection is captured by the sensor(s) while the object is stationary. The object under inspection is then moved to another location in the given x-y plane, and another image of the object under inspection is captured while the object is stationary at the new location. This process is repeated until a sufficient number of images at different view angles of the object under inspection are captured to reconstruct an image of the object in the given x-y plane.

Once a projection image of at least some portion of the object under inspection is acquired for a number of viewing angles, the interpreter 40 uses mathematical processes known in the art to transform the single set of projection images into a set of layer images, whereby each layer image is a representation of the structural makeup of a conceptual “layer” of the object under inspection. Typically, this transformation consists in part of an averaging process across each of the projection images to emphasize physical characteristics of each conceptual layer of the object. The transformation process may begin as soon as projection images from each of the sensors have been captured for a particular area of the object. One such possible process for converting the projection images into layer images is described in U.S. Pat. No. 5,583,904, to Adams, entitled “Continuous Linear Scan And Laminography System And Method”, hereby incorporated by reference herein for all that it teaches. Alternate methods for performing essentially the same function may also be employed.

After the layer images are generated, the interpreter 40 may then utilize the layer images to determine the overall quality of the object under inspection. For example, in one embodiment where the object under inspection is an electronic printed circuit board, features of each layer, such as printed wires, vias, solder joints, and the like, can be compared automatically to a preexisting set of images or structural measurements to ascertain the physical quality of the PCB. The preexisting set of images or measurements may be generated by way of a theoretical standard or a known good PCB. Furthermore, image processing algorithms known in the art may be employed to process key portions of the layer images to determine overall quality and other desired parameters of those portions.

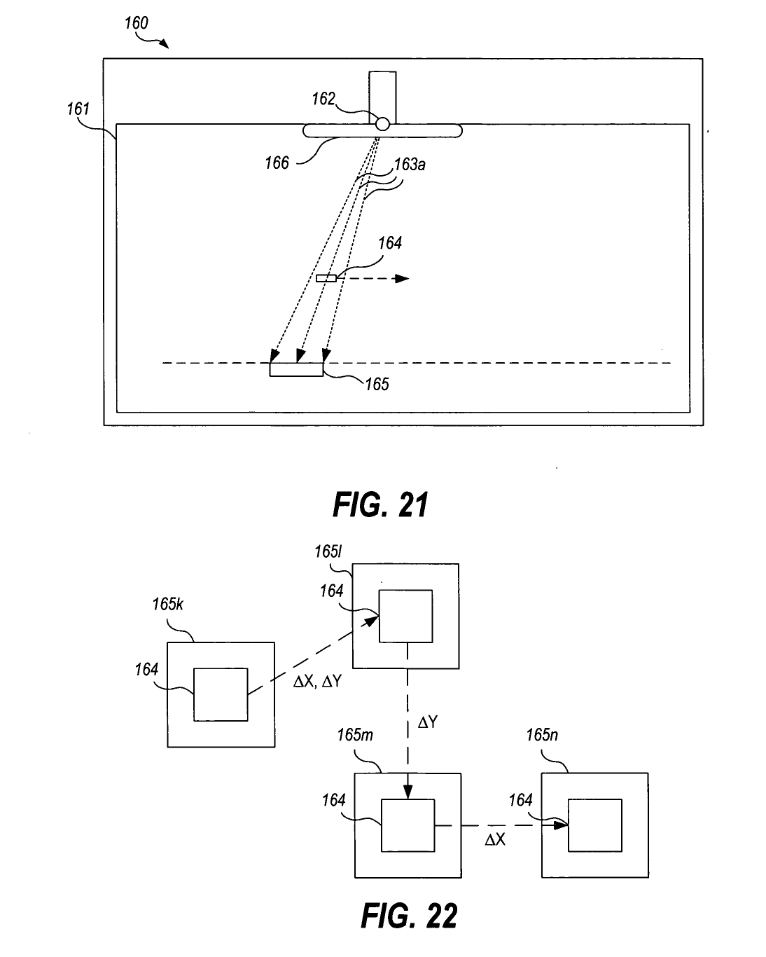

In yet another embodiment, shown in FIG. 21, a system 160 eliminates the use of the field block, relying on a collimator 166 to substantially reduce scatter rays. In this embodiment, the collimator 160 collimates rays generated by an x-ray source 162 to generate rays 163a directed substantially only at one (shown) or more sensors 165. By directing the rays substantially only at the sensor(s) 165 in the system 160, a substantial amount of scatter that might otherwise occur due to undesired rays bouncing off of system walls 161 is eliminated.

In one embodiment, for example as shown in FIG. 22, the object under inspection 164 is transported in two or more directions, indicated by arrows labeled ΔXΔY, ΔY, and ΔX, relative stationary x-ray source(s) (not shown) and stationary sensor(s) 165k, 1651, 165m, 165n.

Although embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An x-ray inspection system, comprising:
one or more x-ray sources;
one or more sensors;
one or more field blocks positioned between the one or more x-ray sources and the one or more sensors, the one or more field blocks configured to pass x-rays sourced directly by the one or more x-ray sources to respective ones of the one or more sensors and to block scattered x-rays from detection by the respective ones of the one or more sensors; and
a relative motion mechanism configured to alter a position of an object under inspection relative to the x-ray source and the one or more sensors, the object under inspection passing between the one or more x-ray sources and the one or more field blocks.

2. The system of claim 1, further comprising:
wherein the position of the object under inspection is altered relative to the x-ray source and the one or more sensors in a single direction.

3. The system of claim 1, wherein the position of the object under inspection is altered relative to the x-ray source and the one or more sensors in two or more different directions.

4. The system of claim 3, wherein a first direction of the two or more different directions is orthogonal to a second direction of the two or more different directions.

5. The system of claim 3, wherein a first direction of the two or more different directions is non-orthogonal to a second direction of the two or more different directions.

6. A method comprising the steps of:
providing one or more x-ray sources;
providing one or more sensors;
limiting respective fields of view of the one or more sensors to pass x-rays sourced directly by the one or more x-ray sources to respective ones of the one or more sensors and to block scattered x-rays from detection by the respective ones of the one or more sensors; and
altering a position of an object under inspection relative to the x-ray source and the one or more sensors, passing the object under inspection between the one or more x-ray sources and the one or more field blocks.

7. The method of claim 6, wherein the step of altering a position of the object under inspection comprises the step of:
altering the position of the object under inspection relative to the x-ray source and the one or more sensors in a single direction.

8. The method of claim 6, wherein the step of altering a position of the object under inspection comprises the step of:
altering the position of the object under inspection relative to the x-ray source and the one or more sensors in two or more different directions.

9. The method of claim 8, wherein a first direction of the two or more different directions is orthogonal to a second direction of the two or more different directions.

10. The method of claim 8, wherein a first direction of the two or more different directions is non-orthogonal to a second direction of the two or more different directions.

11. A method comprising the steps of:
providing one or more x-ray sources;
providing one or more sensors;
providing one or more field blocks positioned between the one or more x-ray sources and the one or more sensors, the one or more field blocks configured to pass x-rays sourced directly by the one or more x-ray sources to respective ones of the one or more sensors and to block scattered x-rays from detection by the respective ones of the one or more sensors; and
providing a position altering mechanism for altering a position of an object under inspection relative to the x-ray source and the one or more sensors, passing the object under inspection between the one or more x-ray sources and the one or more field blocks.

12. The method of claim 11, wherein the position altering mechanism is configured to perform the step of:
altering the position of the object under inspection relative to the x-ray source and the one or more sensors in a single direction.

13. The method of claim 11, wherein the position altering mechanism is configured to perform the step of:
altering the position of the object under inspection relative to the x-ray source and the one or more sensors in two or more different directions.

14. The method of claim 13, wherein a first direction of the two or more different directions is orthogonal to a second direction of the two or more different directions.

15. The method of claim 13, wherein a first direction of the two or more different directions is non-orthogonal to a second direction of the two or more different directions.

16. An x-ray inspection system, comprising:
one or more x-ray sources that generate x-rays;
one or more sensors;
one or more collimators which collimate the x-rays into one or more fan beams directed to illuminate substantially only one or more of the one or more sensors;
one or more field blocks positioned between the one or more x-ray sources and the one or more sensors, the one or more field blocks configured to pass x-rays from the one or more fan beams to respective ones of the one or more sensors and to block scattered x-rays from detection by the respective ones of the one or more sensors; and
a relative motion mechanism configured to alter a position of an object under inspection relative to the one or more x-ray sources and the one or more sensors, the object under inspection passing between the one or more collimators and the one or more field blocks.

17. The system of claim 16, wherein the position of the object under inspection is altered relative to the x-ray source and the one or more sensors in a single direction.

18. The system of claim 16, wherein the position of the object under inspection is altered relative to the x-ray source and the one or more sensors in two or more different directions.

19. The system of claim 18, wherein a first direction of the two or more different directions is orthogonal to a second direction of the two or more different directions.

20. The system of claim 18, wherein a first direction of the two or more different directions is non-orthogonal to a second direction of the two or more different directions.

21. A method comprising the steps of:
providing one or more x-ray sources that generate x-rays;
providing one or more sensors;
collimating the x-rays into one or more fan beams directed to illuminate substantially only one or more of the one or more sensors;
limiting a field of view of the one or more sensors to pass x-rays from the one or more fan beams to respective ones of the one or more sensors and to block scattered x-rays from detection by the respective ones of the one or more sensors; and
altering a position of an object under inspection relative to the one or more x-ray sources and the one or more sensors, passing the object under inspection between the one or more x-ray sources and the one or more sensors through one or more of the fan beams.

22. The method of claim 21, wherein the step of altering a position of the object under inspection comprises the step of:
altering the position of the object under inspection relative to the one or more x-ray sources and the one or more sensors in a single direction.

23. The method of claim 21, wherein the step of altering a position of the object under inspection comprises the step of:
altering the position of the object under inspection relative to the one or more x-ray sources and the one or more sensors in two or more different directions.

24. The method of claim 23, wherein a first direction of the two or more different directions is orthogonal to a second direction of the two or more different directions.

25. The method of claim 23, wherein a first direction of the two or more different directions is non-orthogonal to a second direction of the two or more different directions.

26. A method comprising the steps of:
providing one or more x-ray sources that generate x-rays;
providing one or more sensors;
providing one or more collimators that collimate the x-rays into one or more fan beams directed to illuminate substantially only one or more of the one or more sensors;
providing one or more field blocks positioned between the one or more x-ray sources and the one or more sensors, the one or more field blocks configured to pass x-rays from the one or more fan beams to respective ones of the one or more sensors and to block scattered x-rays from detection by the respective ones of the one or more sensors; and
providing a position altering mechanism for altering a position of an object under inspection relative to the one or more x-ray sources and the one or more sensors, passing the object under inspection between the one or more collimators and the one or more field blocks.

27. The method of claim 26, wherein the position altering mechanism is configured to perform the step of:
altering the position of the object under inspection relative to the x-ray source and the one or more sensors in a single direction.

28. The method of claim 26, wherein the position altering mechanism is configured to perform the step of:
altering the position of the object under inspection relative to the x-ray source and the one or more sensors in two or more different directions.

29. The method of claim 28, wherein a first direction of the two or more different directions is orthogonal to a second direction of the two or more different directions.

30. The method of claim 28, wherein a first direction of the two or more different directions is non-orthogonal to a second direction of the two or more different directions.

31. An x-ray inspection system, comprising:
one or more x-ray sources;
one or more sensors;
one or more field blocks positioned between the one or more x-ray sources and the one or more sensors, the one or more field blocks configured to pass x-rays sourced directly by the one or more x-ray sources to respective ones of the one or more sensors and to block scattered x-rays from detection by the respective ones of the one or more sensors; and
a relative motion mechanism configured to alter a position of an object under inspection relative to the x-ray source and the one or more sensors in two or more directions, the object under inspection passing between the one or more x-ray sources and the one or more field blocks.

32. The system of claim 31, wherein a first direction of the two or more different directions is orthogonal to a second direction of the two or more different directions.

33. The system of claim 31, wherein a first direction of the two or more different directions is non-orthogonal to a second direction of the two or more different directions.

34. A method comprising the steps of:
providing one or more x-ray sources;
providing one or more sensors;
providing one or more field blocks positioned between the one or more x-ray sources and the one or more sensors, the one or more field blocks configured to pass x-rays sourced directly by the one or more x-ray sources to respective ones of the one or more sensors and to block scattered x-rays from detection by the respective ones of the one or more sensors; and
altering a position of an object under inspection relative to the x-ray source and the one or more sensors in two or more directions, passing the object under inspection between the one or more x-ray sources and the one or more field blocks.

35. The method of claim 34, wherein a first direction of the two or more different directions is orthogonal to a second direction of the two or more different directions.

36. The method of claim 34, wherein a first direction of the two or more different directions is non-orthogonal to a second direction of the two or more different directions.

37. A method comprising the steps of:
providing one or more x-ray sources;
providing one or more sensors;
providing one or more field blocks positioned between the one or more x-ray sources and the one or more sensors, the one or more field blocks configured to pass x-rays sourced directly by the one or more x-ray sources to respective ones of the one or more sensors and to block scattered x-rays from detection by the respective ones of the one or more sensors; and
providing a position altering mechanism for altering a position of an object under inspection relative to the x-ray source and the one or more sensors in two or more directions, passing the object under inspection between the one or more x-ray sources and the one or more field blocks.

38. The method of claim 37, wherein a first direction of the two or more different directions is orthogonal to a second direction of the two or more different directions.

39. The method of claim 37, wherein a first direction of the two or more different directions is non-orthogonal to a second direction of the two or more different directions.

40. An x-ray inspection system, comprising:
one or more x-ray sources that generate x-rays;
one or more sensors;
one or more collimators which collimate the x-rays into one or more fan beams directed to illuminate substantially only one or more of the one or more sensors;
one or more field blocks positioned between the one or more x-ray sources and the one or more sensors, the one or more field blocks configured to pass x-rays from the one or more fan beams to respective ones of the one or more sensors and to block scattered x-rays from detection by the respective ones of the one or more sensors; and
a relative motion mechanism configured to alter a position of an object under inspection relative to the one or more x-ray sources and the one or more sensors in two or more directions, the object under inspection passing between the one or more collimators and the one or more field blocks.

41. The system of claim 40, wherein a first direction of the two or more different directions is orthogonal to a second direction of the two or more different directions.

42. The system of claim 40, wherein a first direction of the two or more different directions is non-orthogonal to a second direction of the two or more different directions.

43. A method comprising the steps of:
providing one or more x-ray sources that generate x-rays;
providing one or more sensors;
providing one or more collimators that collimate the x-rays into one or more x-ray beams directed to illuminate substantially only one or more of the one or more sensors;
providing one or more field blocks positioned between the one or more x-ray sources and the one or more sensors, the one or more field blocks configured to pass x-rays from the one or more fan beams to respective ones of the one or more sensors and to block scattered x-rays from detection by the respective ones of the one or more sensors; and
altering a position of an object under inspection relative to the one or more x-ray sources and the one or more sensors in two or more directions, passing the object under inspection between the one or more collimators and the one or more field blocks.

44. The method of claim 43, wherein a first direction of the two or more different directions is orthogonal to a second direction of the two or more different directions.

45. The method of claim 43, wherein a first direction of the two or more different directions is non-orthogonal to a second direction of the two or more different directions.

46. A method comprising the steps of:
providing one or more x-ray sources that generate x-rays;
providing one or more sensors;
providing one or more collimators that collimate the x-rays into one or more fan beams directed to illuminate substantially only one or more of the one or more sensors;
providing one or more field blocks positioned between the one or more x-ray sources and the one or more sensors, the one or more field blocks configured to pass x-rays from the one or more fan beams to respective ones of the one or more sensors and to block scattered x-rays from detection by the respective ones of the one or more sensors; and
providing a position altering mechanism for altering a position of an object under inspection relative to the one or more x-ray sources and the one or more sensors, passing the object under inspection between the one or more collimators and the one or more field blocks.

47. The method of claim 46, wherein a first direction of the two or more different directions is orthogonal to a second direction of the two or more different directions.

48. The method of claim 46, wherein a first direction of the two or more different directions is non-orthogonal to a second direction of the two or more different directions.

49. An x-ray inspection system, comprising:
a single x-ray source the generates x-rays;
one or more sensors;
one or more collimators that collimate the x-rays into one or more fan beams directed to illuminate substantially only one or more of the one or more sensors;
one or more field blocks positioned between the single x-ray source and the one or more sensors, the one or more field blocks configured to pass x-rays from the one or more fan beams to respective ones of the one or more sensors and to block scattered x-rays from detection by the respective ones of the one or more sensors; and
a relative motion mechanism configured to alter a position of an object under inspection relative to the single x-ray source and the one or more sensors in two or more directions, the object under inspection passing between the one or more collimators and the one or more field blocks.

50. An x-ray inspection system, comprising:
one or more x-ray sources that generate x-rays;
one or more sensors;
one or more collimators collimate the x-rays into one or more fan beams directed to illuminate substantially only one or more of the one or more sensors; and
a relative motion mechanism configured to alter a position of an object under inspection relative to the one or more x-ray sources and the one or more sensors in two or more directions, the object under inspection passing between the one or more collimators and the one or more sensors.

51. A method for improving x-ray imaging, the method comprising the steps of:
illuminating an object under inspection with x-rays generated by one or more x-ray sources;
limiting a field of view of one or more sensors onto which an image of the illuminated object is projected so as to pass x-rays sourced directly by the one or more x-ray sources to respective ones of the one or more sensors and to block scatter x-rays from detection by the respective ones of the one or more sensors.

52. A method for improving x-ray imaging, the method comprising the steps of:
collimating x-rays generated by one or more x-ray sources into one or more beams directed to illuminate one or more sensors;
illuminating an object under inspection with one or more of the one or more beams;
limiting a field of view of the one or more of the one or more sensors so as to pass x-rays in the one or more beams to the one or more of the one or more sensors and to block scattered x-rays from detection by the one or more of the one or more sensors.
